(19) United States
(12) Patent Application Publication
(10) Pub. No.: US 2026/0083147 A1
(43) Pub. Date: Mar. 26, 2026

(54) METHOD FOR REDUCING CHOLESTEROL IN BEEF TALLOW AND USE THEREOF

(71) Applicant: CHONGQING UNIVERSITY OF EDUCATION, Chongqing (CN)

(72) Inventors: Qiang WANG, Chongqing (CN); Xiaofeng XIANG, Chongqing (CN); Qiangqiang WANG, Chongqing (CN); Yihan WANG, Chongqing (CN); Cao WANG, Chongqing (CN); Kai WANG, Chongqing (CN); Shihua YU, Chongqing (CN)

(21) Appl. No.: 19/403,153

(22) Filed: Nov. 27, 2025

Related U.S. Application Data
(63) Continuation of application No. PCT/CN2025/127432, filed on Oct. 14, 2025.

(30) Foreign Application Priority Data
Sep. 2, 2024 (CN) 202411222467.0

(51) Int. Cl. A23D 9/04; A23L 5/20; B01D 15/08; B01J 20/24; B01J 20/30

(52) U.S. Cl. CPC A23D 9/04; A23L 5/273; B01D 15/08; B01J 20/24; B01J 20/3085

(57) ABSTRACT

The present application discloses a method for reducing cholesterol in beef tallow and use thereof, and relates to the field of food engineering technology. The present application effectively reduces the cholesterol content in beef tallow by adsorbing cholesterol in the beef tallow using β-cyclodextrin and pectin-crosslinked or chitosan-crosslinked β-cyclodextrin complex. In terms of flavor performance, after treatment with the pectin-crosslinked β-cyclodextrin complex, the beef tallow shows significant improvement over untreated beef tallow and beef tallow treated with the chitosan-crosslinked β-cyclodextrin complex. The use of β-cyclodextrin and pectin- or chitosan-crosslinked complex can adjust the hardness of beef tallow, and the prepared beef tallow can be applied in a wider range of scenarios.

### CROSS-REFERENCE TO RELATED APPLICATIONS

This application is a continuation of International Application No. PCT/CN2025/127432, filed on Oct. 14, 2025, which claims priority to Chinese Patent Application No. 202411222467.0, filed on Sep. 2, 2024, both of which are hereby incorporated by reference in their entireties.

### TECHNICAL FIELD

The present application relates to the field of food engineering technology, and specifically to a method for reducing cholesterol in beef tallow and use thereof.

### BACKGROUND

Compared with vegetable oils, beef tallow, although rich in nutrients, has a higher melting point and smoke point, is relatively stable, and is less prone to oxidation and deterioration. However, beef tallow contains a high cholesterol content, which, while contributing to the rich and unique flavor of hot pot, may increase the risk of obesity, hypertension, heart disease, and atherosclerosis when consumed in excess, thus increasing the risk of related cardiovascular diseases.

Currently, methods for removing cholesterol from food are mainly divided into three categories: physical methods (such as adsorbent adsorption, distillation, and supercritical extraction), chemical methods (such as inclusion methods and solvent extraction), and biological methods (such as lipase oxidation and microbial methods). In these methods, the use of β-cyclodextrin (β-CD) adsorption or inclusion method to remove cholesterol has attracted considerable attention due to the advantages, such as low cost, food safety, non-toxicity, and ease of operation, which has been widely applied in industries such as beef tallow, lard, and dairy products. JIA et al. synthesized a corn protein-grafted-β-CD film, with β-CD as the main component, which exhibited a maximum cholesterol adsorption capacity of only 5.70 mg/g. This adsorption capacity is insufficient for practical application in food engineering, and no highly effective methods for significantly reducing cholesterol have been found in existing technologies.

### SUMMARY

Aiming at the defects in the prior art, the present application provides a method for reducing cholesterol in beef tallow by effectively adsorbing the cholesterol in the beef tallow and use thereof.

To achieve the above objective, the present application adopts the following technical solutions.

Provided is a method for reducing cholesterol in beef tallow, which includes the following steps:

S1: melting beef tallow in a water bath at 80° C., and slowly adding water to melted beef tallow while maintaining the temperature at 80° C. during the addition of the water;

S2: adding β-cyclodextrin, chitosan-crosslinked β-cyclodextrin complex, or pectin-crosslinked β-cyclodextrin complex to a mixture of the beef tallow and the water, and stirring at 50° C. for 1 h; and

S3: centrifuging after stirring is completed, extracting an upper sample to complete the reduction of cholesterol in the beef tallow.

Further, a ratio of the beef tallow to the water is 50 g:180 mL, and the water is preheated to the same temperature as the beef tallow before adding to the beef tallow.

Further, a mass ratio of the β-cyclodextrin, the chitosan-crosslinked β-cyclodextrin complex, or the pectin-crosslinked β-cyclodextrin complex to the beef tallow in the step S2 is 3:100.

Further, a method for preparing the pectin-crosslinked β-cyclodextrin complex is as follows:
A1: dissolving pectin in a 1.0 mol/L HCl solution, where a ratio of the pectin to the HCl solution is 1 g:120 mL;
A2: adding β-cyclodextrin to the mixed solution, heating to 85° C., and maintaining the temperature for 20 min;
A3: adding a 50% (w/w) glutaraldehyde solution and stirring at 350 rpm at 60° C. for 5 h to obtain an orange-yellow solution; and
A4: adding anhydrous ethanol into the orange-yellow solution to form a precipitate, centrifuging, and drying the precipitate to obtain the pectin-crosslinked β-cyclodextrin complex.

Further, a mass ratio of the β-cyclodextrin to the pectin is 10:1.

Further, a volume ratio of the anhydrous ethanol to the HCl solution is 4:1.

Further, a method of preparing the chitosan-crosslinked β-cyclodextrin complex is as follows:
B1: adding β-cyclodextrin to a 1% acetic acid solution, stirring to dissolve, then adding chitosan powder, and stirring to react for 45 min;
B2: adding the solution after the reaction is completed dropwise to a mixture of NaOH and ethanol solution, leaving to stand for 1 h to solidify, followed by filtering to obtain spherical particles; and
B3: drying the spherical particles at 40° C. for 6 h, thus obtaining the chitosan-crosslinked β-cyclodextrin complex.

Further, a ratio of the β-cyclodextrin to the acetic acid solution is 4 g:100 mL, and a mass ratio of the β-cyclodextrin to the chitosan powder is 4:3.

Further, the mixture of NaOH and ethanol solution is a 1.00 mol/L NaOH solution and a 26% ethanol solution mixed in a volume ratio of 1:1.

Low-cholesterol beef tallow is prepared by the method of reducing cholesterol in beef tallow as described above.

The beneficial effects of the present application are as follows:

The present application effectively reduces the cholesterol content in beef tallow by adsorbing cholesterol in the beef tallow using β-cyclodextrin and pectin-crosslinked or chitosan-crosslinked β-cyclodextrin complex. In terms of flavor performance, after treatment with the pectin-crosslinked β-cyclodextrin complex, the beef tallow shows significant improvement over untreated beef tallow and beef tallow treated with the chitosan-crosslinked β-cyclodextrin complex.

The use of β-cyclodextrin and pectin-or chitosan-crosslinked complex can adjust the hardness of beef tallow, and the prepared beef tallow can be applied in a wider range of scenarios.

### BRIEF DESCRIPTION OF THE DRAWINGS

FIG. 1 is a chart showing the cholesterol measurement results of the beef tallow treated in Example 5;

FIG. 2 is a radar diagram of the volatile substance analysis of the beef tallow treated in Example 7;

FIG. 3 is a radar diagram of the sensory evaluation of the beef tallow treated in Example 7; and

FIG. 4 is a line chart of the shear rate and the viscosity of the beef tallow treated in Example 8.

### DESCRIPTION OF EMBODIMENTS

The following description of the specific embodiments of the present application is provided to facilitate the understanding of the present application by those skilled in the art, however, it should be understood that the present application is not limited to the scope of the specific embodiments, and for those of ordinary skill in the art, various changes that are made without departing from the spirit and scope of the present application as defined and determined by the appended claims are apparent, and all inventions and creations that are made by using the concept of the present application are within the protective scope.

### Example 1. Preparation of Pectin-Crosslinked β-cyclodextrin Complex

The method for preparing the pectin-crosslinked β-cyclodextrin complex was as follows:
A1: 1 g of pectin was dissolved in 120 mL of a 1.0 mol/L HCl solution; in a specific implementation, the solution was stirred at 300 rpm for 1.5 h using a thermostatic magnetic stirrer until the solution was free of lumps.
A2: 10 g of β-cyclodextrin was added to the mixed solution, and the solution was heated to 85° C. for 20 min using a digital constant-temperature water bath (HH-2, Shanghai Hongxing Instruments Co., Ltd.) until the solution became transparent.
A3: 3 mL of a 50% (w/w) glutaraldehyde solution was added, and the reaction was stirred at 350 rpm in a 60°° C. water bath for 5 h to obtain an orange-yellow solution.
A4: 480 mL of anhydrous ethanol was added to the orange-yellow solution to form a precipitate, which was then centrifuged at 8000 rpm for 15 min. The precipitate was placed in a 40° C. constant-temperature drying oven for 1 h to obtain the pectin-crosslinked β-cyclodextrin complex.

### Example 2. Reduction of Cholesterol in Beef Tallow by Pectin-Crosslinked β-cyclodextrin Complex

The specific method was as follows:
S1: 50 g of beef tallow was melted in an 80° C. water bath, and 180 mL of water was slowly added to the melted beef tallow. The water was preheated to the same temperature as the beef tallow before being added, and the beef tallow was kept at 80° C. during the addition of the water.
S2: 1.5 g of the pectin-crosslinked β-cyclodextrin complex prepared in Example 1was added to the mixed solution of beef tallow and water, and the mixture was stirred at 500rpm for 1 h at 50° C.
S3: After stirring, the mixture was centrifuged at 1000 rpm for 10 min. The upper oil sample was collected using a scraper, completing the reduction of cholesterol in the beef tallow. The upper oil sample was dried and then stored in a light-proof, low-temperature sealed container to obtain the cholesterol-reduced beef tallow treated with pectin-crosslinked β-cyclodextrin complex (Pctin-β-CD).

### Example 3. Preparation of Chitosan-Crosslinked β-cyclodextrin Complex

The method for preparing the chitosan-crosslinked β-cyclodextrin complex was as follows:
B1: 4 g of β-cyclodextrin was added to 100 mL of a 1% acetic acid solution, and the β-cyclodextrin was fully dissolved by stirring. Afterward, 3 g of chitosan powder was added, and the mixture was stirred for 45 min using a thermostatic magnetic stirrer (Feb-85, Zhengzhou Greatwall Scientific Industrial and Trade Co, Ltd.).
B2: The reaction solution was slowly added dropwise using a hypodermic syringe to a mixed solution of NaOH and ethanol. The mixture was allowed to stand for 1 h to solidify, and then filtered to obtain spherical particles. The NaOH and ethanol mixed solution was prepared by mixing a 1.00 mol/L NaOH solution and a 26% ethanol solution in a 1:1volume ratio.
B3: The spherical particles were dried in a thermostatic drying oven (FB204, Shanghai Yoke Instrument Co., Ltd.) at 40° C. for 6 h to obtain the chitosan-crosslinked β-cyclodextrin complex.

### Example 4. Reduction of Cholesterol in Beef Tallow by Chitosan-Crosslinked β-cyclodextrin Complex

The specific method of this example was similar to that of Example 2, and the difference was as follows: in step S2, 1.5 g of the chitosan-crosslinked β-cyclodextrin complex prepared in Example 3 replaced 1.5 g of the pectin-crosslinked β-cyclodextrin complex prepared in Example 1. The cholesterol-reduced beef tallow treated with chitosan-crosslinked β-cyclodextrin complex (CS-β-CD) was obtained.

### Example 5: Cholesterol Measurement of Treated Beef Tallow

Untreated beef tallow (Blank) was set as a control group 1; a method similar to that in Example 2 was used, the difference was as follows: 1.5 g of β-cyclodextrin replaced 1.5 g of the pectin-crosslinked β-cyclodextrin complex prepared in Example 1, resulting in beef tallow treated with β-cyclodextrin for cholesterol reduction (β-CD), which was used as control group 2.

Cholesterol content was measured in the untreated beef tallow (Blank), the beef tallow treated with β-cyclodextrin for cholesterol reduction (β-CD), the beef tallow prepared in Example 2 (Pctin-β-CD), and the beef tallow prepared in Example 4 (CS-β-CD), and the cholesterol removal rate was calculated. The specific method for measuring cholesterol content is as follows: 3 mg of solid beef tallow (accurate to 0.0001 g) was accurately weighed and placed in a 50 mL iodine flask, and melted in a 65° C. water bath; 4 mL of anhydrous ethanol and 0.5 mL of 50% potassium hydroxide solution were sequentially added and mixed by vortexing; and the mixture was placed in a 65° C. constant-temperature water bath for saponification for 1 h. During the saponification process, the mixture was shaken every 20 min to ensure complete saponification. After saponification, the iodine flask was taken out and washed with flowing cold water. Then, 3 mL of 5% sodium chloride solution and 10 mL of petroleum ether were added, and the iodine flask was tightly sealed. The mixture was vortexed for 120 s and allowed to stand for 60 min for layering. 2 mL of the upper layer of petroleum ether was taken and added to a 10 mL stoppered glass test tube. The test tube was placed in a 65° C. water bath to evaporate the petroleum ether and dried with nitrogen. Then, 4 mL of ice acetic acid solution and 2 mL of iron (III) sulfate color reagent were added, mixed well, and allowed to stand for 15 min. The absorbance was measured at a wavelength of 560 nm, and the cholesterol content was calculated from the standard cholesterol curve. The cholesterol removal rate was then calculated.

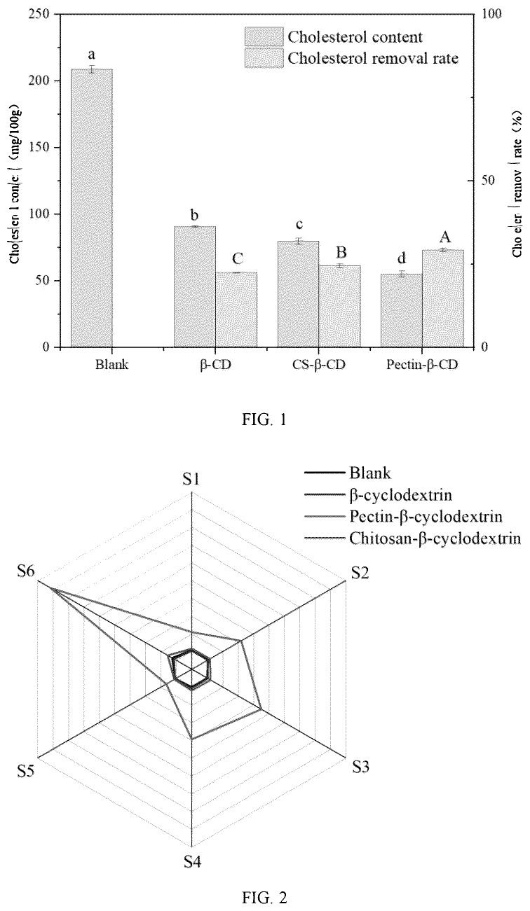

The results are shown in FIG. 1. As shown in FIG. 1, the use of β-cyclodextrin, pectin-crosslinked β-cyclodextrin complex, and chitosan-crosslinked β-cyclodextrin complex all significantly reduces the cholesterol content in beef tallow. The cholesterol content of the beef tallow treated with chitosan-crosslinked β-cyclodextrin complex (CS-β-CD) is 80.08 mg/100 g, with a cholesterol removal rate of 61.67%; the cholesterol content of the beef tallow treated with β-cyclodextrin (β-CD) is 91.01 mg/100 g, with a cholesterol removal rate of 56.46%; and the cholesterol content of the beef tallow treated with pectin-crosslinked β-cyclodextrin complex (Pctin-β-CD) is 55.51 mg/100 g, with a cholesterol removal rate of 73.43%.

The cholesterol removal effect of the pectin-crosslinked β-cyclodextrin complex on beef tallow was significantly better than that of other beef tallow. The present application significantly outperforms the method disclosed in “Interaction Analysis of β-cyclodextrin and Its Derivatives with Cholesterol and Its Application in the Removal of Cholesterol from Tallow [D]. Southwest University, 2023”, which uses HP-β-CD to remove cholesterol from beef tallow, achieving a cholesterol removal rate of 51.39%.

Furthermore, the cholesterol removal method used in the present application is superior to the method disclosed in “Preparation of Low-Cholesterol Beef Tallow and Its Physicochemical Properties Analysis, Food and Fermentation Industry, 2020, 46 (22): 187-195”, which uses β-cyclodextrin to treat beef tallow, achieving a cholesterol removal rate of 47.23%.

In conclusion, the cholesterol removal effect of the pectin-crosslinked β-cyclodextrin complex or chitosan-crosslinked β-cyclodextrin complex used in the present application is superior to that of β-CD and the derivatives of β-CD in the treatment of low-cholesterol beef tallow. In addition, the cholesterol removal method used in the present application is also superior to the existing technology.

### Example 6: Measurement of Hardness of Beef Tallow

The hardness of the four types of beef tallow from Example 5 was measured using a texture analyzer (TA.XTC-18, Shanghai Bosin Industrial Development Co., Ltd.). A wedge-shaped probe was selected, and the following parameters were set: pre-test, middle, and post-test probe speeds were 1.00, 1.00, and 3.00 mm/s, respectively. The time interval between the two probe tests was 5 s, the trigger load force was 5 g, and the compression deformation was 20%. After each measurement, the probe was cleaned, and the measurement was repeated three times. The results are shown in Table 1. As shown in Table 1, the use of chitosan-crosslinked β-cyclodextrin complex for cholesterol reduction treatment of beef tallow increases the hardness of the beef tallow. However, the use of pectin-crosslinked β-cyclodextrin complex for cholesterol reduction treatment of beef tallow decreases the hardness of the beef tallow, which improves the convenience of use by reducing the hardness of the beef tallow. The change in the hardness expanded the application scenarios of the beef tallow.

TABLE 1

| | Blank | β-CD | CS-β-CD | Pectin-β-CD |
|---|---|---|---|---|
| Hardness (g) | 652.96 ± 87.63^{b} | 663.57 ± 45.29^{b} | 810.69 ± 32.78^{a} | 628.65 ± 66.19^{b} |

Superscript ^{a-b} indicates significant differences within the same row (p < 0.05).

### Example 7. Sensory Evaluation of Beef Tallow Aroma and Volatile Substance Analysis

The four types of beef tallow from Example 5 were analyzed using an electronic nose (cNose-6, Shanghai Bosin Industrial Development Co., Ltd.). The electronic nose sensor is composed of S1-S6 sensors, and the sensor types and response substances are shown in Table 2. 3 g (±0.001 g) of each of the 4 samples was accurately weighed and placed in headspace vials. The vials were heated in an 80° C. water bath for 20 min until melted, allowing the sample gases to fill the headspace vials. The electronic nose probe was inserted, and the air at the top was sampled for measurement. Electronic nose test conditions: sample test time was 350 s, sampling interval was 1 s, and cleaning time was 100 s. Each sample test was repeated 3 times.

TABLE 2

| Sensor types | Response substances |
|---|---|
| S1 | Short-chain alkanes, nitrogen oxides, and carbides |
| S2 | Sensitive to aldehydes, ketones, alcohols, nitrogen oxides, and carbides |
| S3 | Selective to amines, sensitive to sulfur compounds and benzene-based aromatic |
| | components |
| S4 | Sensitive to organic sulfur compounds and short-chain alkanes |
| S5 | Sensitive to amine aromatic components |
| S6 | Selective to benzene-based aromatic components, sensitive to aldehydes, ketones, |
| | and alcohols |

The measurement results are plotted into a radar chart as shown in FIG. 2. As shown in FIG. 2, the response value of beef tallow Pectin-β-CD (Pectin-β-cyclodextrin) to the S6 signal is significantly higher than that of other sensors, which indicates that the beef tallow Pectin-β-CD is selective to the benzene-based aromatic components and is sensitive to aldehydes, ketones and alcohols; secondly, the beef tallow Pectin-β-CD is selective to the aldehydes, ketones, alcohols, nitrogen oxides, carbides (S2), and selective to amines, sensitive to sulfur compounds and benzene-based aromatic components (S3); and has high response value for the organic sulfur compounds and the short-chain alkanes (S4). The response value trends of the other three samples including blank beef tallow (Blank), beef tallow CS-β-CD (Chitosan-β-cyclodextrin), and beef tallow β-CD (β-cyclodextrin), were almost identical, proving that the aroma compositions of the other three samples are similar.

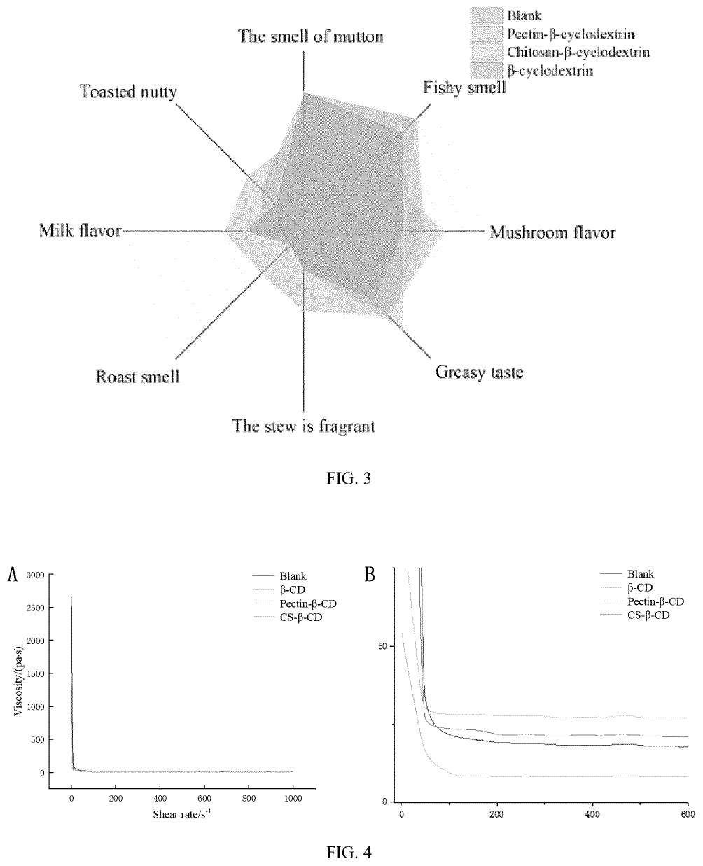

A panel of 17 individuals with keen sense of smell was selected and trained to participate in aroma evaluation. The sensory evaluation of the beef tallow was conducted based on 8 typical aromas: the smell of mutton, fishy smell, mushroom flavor, greasy taste, the stew fragrance, roast smell, milk flavor, and toasted nutty, and the 4 samples were scored. The results are shown in FIG. 3. It can be concluded that the blank beef tallow (Blank) is mainly characterized by the smell of mutton and fishy smell, while beef tallow CS-β-CD (Chitosan-β-cyclodextrin) has a similar mutton and fishy smell to the blank beef tallow (Blank), but with a more prominent greasy taste. Beef tallow β-CD (β-cyclodextrin) shows a more noticeable milk flavor. Beef tallow Pectin-β-CD (Pectin-β-cyclodextrin) shows a significantly higher roasted nutty flavor, milk flavor, roasted meat aroma, and mushroom flavor compared to the other three beef tallow samples, with a reduction in mutton and fishy smells. This indicates that the pectin-crosslinked β-cyclodextrin complex effectively improves the quality of the beef tallow.

In conclusion, based on the sensory evaluation results, it can be concluded that the aroma composition of beef tallow treated with pectin-crosslinked β-cyclodextrin complex is improved.

### Example 8: Measurement of Viscosity of Beef Tallow

The relationship between shear rate and viscosity of the four types of beef tallow from Example 5 was measured at 50° C., and the results are shown in FIG. 4, where FIG. 4B is an enlarged view of FIG. 4A for the shear rate of 0-600 s⁻¹. As shown in FIG. 4, the rheological characteristics of the blank beef tallow (Blank) and the three processed beef tallow samples are almost identical. The shear rate from 0 to 100 s⁻¹ exhibits distinct non-Newtonian fluid behavior, and as the shear rate increases, the viscosity gradually decreases and eventually stabilizes. This is because the increased shear rate facilitates a more stable and uniform fluid state of the beef tallow sample. Furthermore, as the temperature increases, the thermal motion of the oil molecules accelerates, which increases the fluidity between the molecules, thereby reducing the intermolecular forces and lowering the viscosity of the oil sample. The viscosity of the beef tallow Pectin-β-CD is slightly lower than that of the other processed beef tallow and blank beef tallow, indicating that treatment with pectin-crosslinked β-cyclodextrin complex can reduce the adhesion of beef tallow to some extent, which is expected to reduce the amount of fat adhesion in the human body during consumption, thereby benefiting dietary health.

What is claimed is:

1. A method for reducing cholesterol in beef tallow, reducing hardness of beef tallow, improving aroma and flavor of beef tallow, and reducing viscosity of beef tallow using pectin-crosslinked β-cyclodextrin complex, comprising the following steps: S1: melting beef tallow in an 80° C. water bath, and slowly adding water to melted beef tallow, while maintaining the temperature of the beef tallow at 80° C. during the addition of water; S2: adding pectin-crosslinked β-cyclodextrin complex to a mixture of the beef tallow and the water, and stirring at 50° C. for 1 h; and S3: after stirring, centrifuging and extracting an upper oil sample to complete reduction of cholesterol in the beef tallow, reduction of hardness of the beef tallow, improvement of aroma and flavor of the beef tallow, and reduction of viscosity of the beef tallow; wherein the flavor comprises toasted nutty, milk flavor, roast smell and mushroom flavor.

2. The method according to claim 1, wherein a ratio of the beef tallow to the water is 50 g: 180 mL, and the water is preheated to the same temperature as the beef tallow before adding to the beef tallow.

3. The method according to claim 1, wherein a method for preparing the pectin-crosslinked β-cyclodextrin complex is as follows: A1: dissolving pectin in a 1.0 mol/L HCl solution, wherein a ratio of the pectin to the HCl solution is 1 g:120 mL; A2: adding β-cyclodextrin to the mixed solution, heating to 85° C., and maintaining the temperature for 20min; A3: adding a 50% (w/w) glutaraldehyde solution and stirring at 350 rpm at 60° C. for 5 h to obtain an orange-yellow solution; and A4: adding anhydrous ethanol into the orange-yellow solution to form a precipitate, centrifuging, and drying the precipitate to obtain the pectin-crosslinked β-cyclodextrin complex.

4. The method according to claim 3, wherein a mass ratio of the β-cyclodextrin to the pectin is 10:1.

5. The method according to claim 3, wherein a volume ratio of the anhydrous ethanol to the HCl solution is 4:1.
